(19) United States
(12) Patent Application Publication
(10) Pub. No.: US 2019/0116805 A1
(43) Pub. Date: Apr. 25, 2019

(54) CITRUS BASED ANTIMICROBIAL SOLUTION

(71) Applicant: FRESHGUARD DEFENSE, INC., Long Lake, MN (US)

(72) Inventors: PATRICIA M. LOPESIO, LONG LAKE, MN (US); LISA A. ZURAW, CHARLESTON, SC (US)

(21) Appl. No.: 16/221,771

(22) Filed: Dec. 17, 2018

Related U.S. Application Data
(63) Continuation-in-part of application No. 14/289,854, filed on May 29, 2014, now Pat. No. 10,182,573.
Application No. 14/289,854 is a continuation-in-part of application No. 12/931,936, filed on Feb. 15, 2011, now abandoned.

(51) Int. Cl. A01N 65/36; A01N 37/02; A01N 25/34; A01N 25/02; A63B 71/08

(52) U.S. Cl. CPC A01N 65/36; A01N 37/02; A01N 25/30; A01N 25/02; A63B 71/085; A01N 25/34

(57) ABSTRACT

In various aspects, the composition of matter disclosed herein includes an antimicrobial solution. The antimicrobial solution may include water and extracted material obtained by solvent extraction from one or more of seeds, pulp, and fruit of a plant of the genus Citrus, in various aspects. The extracted material has anti-microbial properties and is at a concentration in said antimicrobial solution effective to eradicate micro-organisms that may include both Gram-positive micro-organisms and Gram-negative micro-organisms, in various aspects. The antimicrobial solution may include acetic acid buffered by a buffer to maintain said antimicrobial solution at a pH between about 4 and about 6. The antimicrobial solution may include a surfactant comprising one or more surfactant materials selected from glycerides of a vegetable oil, fatty acids of the vegetable oil, esters of fatty acids of the vegetable oil, ethoxylated vegetable oil. The antimicrobial solution may include colorant and may include flavorant.

### CROSS-REFERENCE TO RELATED APPLICATIONS

The present application is a continuation-in-part of U.S. patent application Ser. No. 14/289,854 filed 29 May 2014 that, in turn, is a continuation-in-part of U.S. patent application Ser. No. 12/931,936 filed 15 Feb. 2011. U.S. patent application Ser. No. 14/289,854 filed 29 May 2014 and U.S. patent application Ser. No. 12/931,936 filed 15 Feb. 2011 are hereby incorporated by reference in their entireties herein.

### BACKGROUND OF THE INVENTION

### Field

This disclosure relates to an antimicrobial solution, and, more specifically, to an antimicrobial solution that may eradicate micro-organisms growing on solid surfaces such as dental appliances.

### Background of the Related Art

Micro-organisms may grow upon solid surfaces such as the surface of a dental appliance and inside pores in the materials of which the dental appliance is comprised. These micro-organisms may cause malodor and may pose a health hazard to the user. For example, micro-organisms found upon a dental appliance may include disease-causing organisms such as Staphylococcus, Streptococcus, and Pneumococcus. Pore may include, for example, pores, cracks, crevices, cavities, scratches, and surface imperfections. The dental appliance may include a metal portion and a plastic portion, and pores may be found in the metal portion, in the plastic portion, or both the metal portion and the plastic portion.

Unless the user cleans the dental appliance to remove the micro-organisms, the micro-organisms on the dental appliance may cause gum infections and tooth decay. The micro-organisms may travel from the dental appliance to the lungs to produce exercise-induced asthma and other illnesses. Micro-organisms reaching the stomach from the dental appliance may produce toxins causing nausea, vomiting and diarrhea. Moreover, if the user has cuts or irritation of the tissue of the mouth, micro-organisms such as Staphylococcus aureus may enter the bloodstream during use of the dental appliance. In extreme cases, diseases resulting from micro-organisms on the dental appliance may be fatal.

In a personal case involving the son of one of the inventors, the combination of a broken tooth and a dirty dental appliance (a mouth guard) resulted in a severe staph infection that ate away at the bone and cartilage in the base of his nose. Treatment included three surgeries and resulted in the missing of two months of school and three-plus months of the athletic season. This case is indicative of the danger associated with a dirty dental appliance, and motivated the search for an appropriate cleaner for dental appliances.

Methods known for cleaning a dental appliance include rinsing with water, soap and water, toothpaste, or denture cleaners. These methods may leave at least 10% of the micro-organisms on the dental appliance. Such approaches may be ineffective in removing micro-organisms trapped inside pores of the dental appliances, and may not remove foreign matter including embedded odors from the dental appliance.

Many products for cleaning dental appliances may contain components like zinc, Triclostan, bleaching agents, persulfate, monopersulfate, and ethylenediaminetraacetic acid (“EDTA”), which is a metal ion chelating agent and blood thinner. Such components may cause allergic reactions, and even more severe injuries like permanent neurological nerve damage to the user if ingested. Such allergic reactions may include tissue damage; rashes, hives, and irritations; gum tenderness; breathing problems; kidney failure; and low blood pressure. These serious incidents arising from the use of such products have caused the U.S. Food and Drug Administration (“FDA”) to issue a public health alert in 2008, and require a health warning on the product packaging.

There may be 40 million mouth guard users in the U.S. Perhaps 35 million people have been diagnosed with TMJ, and the primary treatment is the use of a splint (night guard). A growing population has sleep apnea, which may require the use of a CPAP machine and associated mouth appliance. Additionally, each year 4 million people may be fitted with braces in the U.S. All of these dental appliances are carriers of dangerous germs, bacteria, molds, and, worse yet, may smell awful.

Accordingly, there is a need for improved compositions of matter for the cleaning of a dental appliance.

### BRIEF SUMMARY OF THE INVENTION

These and other needs and disadvantages may be overcome by the composition of matter disclosed herein. Additional improvements and advantages may be recognized by those of ordinary skill in the art upon study of the present disclosure.

In various aspects, the composition of matter disclosed herein includes an antimicrobial solution. The antimicrobial solution may include water and one or more materials selected from a group consisting of extracted material and solvent. The extracted material is obtained by extraction using the solvent from one or more of seeds, pulp, and fruit of a plant of the genus Citrus, in various aspects. At least one of the one or more materials has anti-microbial properties and is at a concentration in said antimicrobial solution effective to eradicate micro-organisms, in various aspects. The antimicrobial solution may include acetic acid buffered by a buffer to maintain said antimicrobial solution at a pH between about 4 and about 6. The antimicrobial solution may include a surfactant comprising one or more surfactant materials selected from glycerides of a vegetable oil, fatty acids of the vegetable oil, esters of fatty acids of the vegetable oil, ethoxylated vegetable oil. The antimicrobial solution may include colorant and may include flavorant. The flavorant or the colorant may be water soluble, in various aspects.

The composition of matter disclosed herein may include, in various aspects, pores formed in a surface of a dental appliance with micro-organisms resident within the pores, and the surface including the micro-organisms resident within the pores may be in contact with the antimicrobial solution. The dental appliance may be formed as a mouth guard.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by a perspective view portions of an exemplary dental appliance;

FIG. 2 illustrates by a perspective view an exemplary antimicrobial dental appliance cleaning kit;

FIG. 3 illustrates by a perspective view portions of the exemplary cleaning kit of FIG. 2 opened to show the exemplary dental appliance of FIG. 1 contained therein;

FIG. 4 illustrates by a perspective view an exemplary package of towelettes;

FIG. 5 illustrates by a schematic view an exemplary implementation of the packaged towelettes of FIG. 4;

FIG. 6 illustrates by a schematic view another exemplary implementation of the packaged towelettes of FIG. 4;

FIG. 7 illustrates by a schematic view yet another implementation of the packaged wet wipes towelettes of FIG. 4;

FIG. 8 illustrates by bar chart results of a test of the exemplary antimicrobial solution of Table 1 against various micro-organisms;

FIG. 9A illustrates by side cut-away view an implementation of the antimicrobial solution in use with portions of an exemplary dental appliance;

FIG. 9B illustrates by side cut-away view an implementation of a towlette in combination with an exemplary antimicrobial solution in use with portions of an exemplary dental appliance;

FIG. 10 illustrates by bar chart the results of tests of various exemplary formulations of the antimicrobial solution as given in Table 4 against various micro-organisms; and,

FIG. 11 illustrates by structural formula an exemplary ethoxylated fatty acid.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow, composition, and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION

A composition of matter is disclosed herein. In various aspects, the composition of matter includes a dental appliance, and the dental appliance may be formed of metal, plastic, or combinations of metal and plastic. The metal or plastic may be porous, and micro-organisms may be resident within the pores. The composition of matter may include an antimicrobial solution that may be in contact with the dental appliance including micro-organisms resident within the pores. In various aspects, the antimicrobial solution includes a plant-based antimicrobial extract at a concentration effective to eradicate the micro-organisms. In various aspects, the antimicrobial solution may take the form of a rinse that eradicates micro-organisms from the dental appliance immersed therein. The antimicrobial solution may be incorporated into a towelette that may be applied to the dental appliance including porous plastic material portions thereof in order to eradicate micro-organisms resident upon the dental appliance, in some aspects. The antimicrobial solution may be effective to eradicate both various Gram-negative and various Gram-positive bacteria.

The antimicrobial solution disclosed herein, in various aspects, contains only natural ingredients for eradicating micro-organisms from the dental appliance and removing foreign material from the dental appliance. The antimicrobial solution may be devoid of metal cation-based antimicrobial agents, in various aspects. The antimicrobial solution disclosed herein, in various aspects, does not include chemicals that might degrade or harden the plastic or metal materials used in the dental appliance. The antimicrobial solution, in various aspects, may be safe to the user should, for example, any of the antimicrobial solution be ingested upon insertion of the dental appliance into the mouth following cleaning using the antimicrobial solution. In various aspects, the components of the antimicrobial solution fall under the umbrella approval of the FDA as “generally recognized as safe” (“GRAS”), meaning that all of the components are generally recognized by qualified experts as being generally safe under the Federal Food, Drug and Cosmetic Act.

As used in this disclosure, dental appliance includes a device worn by the user in the mouth. Dental appliance may include, for example, mouth guards, night guards (splints), orthodontic retainers, the mouth appliance associated with a CPAP machine, dentures, and orthodontic braces. While the antimicrobial solution is generally shown and described herein in conjunction with a dental appliance, it should be recognized that the antimicrobial solution may be useful in the cleaning and disinfection of a variety of other surfaces or materials other than dental appliances, in various aspects.

As used in this disclosure, micro-organism includes microscopic single or multi-cell organism, for example, bacteria, yeasts, molds, and viruses. Micro-organism may include both Gram-positive and Gram-negative bacteria.

As used in this disclosure, plant-based antimicrobial extract includes any substance extracted from the seeds, pulp and/or fruit of a plant of the genus Citrus that has antimicrobial effects, including, for example, those obtained from the species consisting of bergamot or bitter orange (Citrus aurantium); grapefruit (Citrus palxradisi); orange (Citrus sinensis); lemon (Citrus limon); lime (Citrus aurantiifolia); tangerine (Citrus reticulata); mandarin (Citrus reticulata); satsuma (Citrus reticulata); clementine (Citrus reticulata); citron (Citrus medica); pomelo (Citrus grandis); and mixtures thereof.

As used within this disclosure, allergy-inducing agent includes any chemical or other substance that, upon ingestion or topical contact, may cause the user to suffer an allergic reaction, such as inflammation, hives, skin irritation, itching, wheezing, anaphylactic swelling, nausea, diarrhea. Such agents may include, for example, sodium monopersulfate, sodium perborate, persulfates, and EDTA.

As used in this disclosure, safe and effective amount includes an amount of a plant-based antimicrobial extract or other antimicrobial compound or component sufficient to significantly induce a positive benefit, but low enough to avoid a serious side effect in the user—that is, to provide a reasonable benefit to risk ratio within the scope of sound medical judgment.

As used in this disclosure, chemically-derived malodor control agent includes chemically produced antimicrobial agents like 5-chloro-2-(2,4-dichlorophenoxy)-phenol (commonly known as Triclosan); phthalic acid and salts of phthalic acid, for example, magnesium mono-potassium phthalate, including but not limited to those disclosed in U.S. Pat. No. 4,994,262; chlorhexidine; alexidine; hexetidine; sanguinarine; benzalkonium chloride; salicylanilide; domiphen bromide; cetylpyridinium chloride; tetradecylpyridinium chloride; N-tetradecyl-4-ethylpyridinium chloride; octenifine; delmopinol; octapinol; and other piperidine derivatives; nicin preparations; zinc/stannous ion agents; antibiotics such as augmentin, amoxicilline, tetracycline, doxycycline, minocycline, and metronidazole; and analogues and salts of the above; methyl salicyclate; and mixtures of all of the above.

The antimicrobial solution, as disclosed herein, may comprise: (i) deionized water quantum saris (Q.S); (ii) an effective amount of at least one plant-based antimicrobial extract compound; (iii) glycerin as a stabilizer and dilutant for the plant-based antimicrobial extract compound; (iv) glacial acetic acid as a cleaning agent; (v) sodium acetate as a buffer; (vi) vegetable oil derivative; (vii) a water soluble flavorant; and (viii) a colorant. The plant-based antimicrobial extract compound, glycerin, glacial acetic acid, sodium acetate, vegetable oil derivative, flavorant, and colorant may be generally regarded as benign at the concentrations of these components in various implementations of the antimicrobial solution.

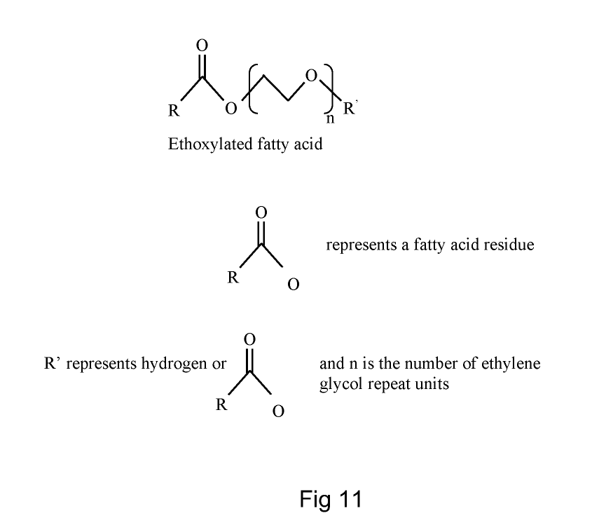

Vegetable oil may be extracted from seeds or sometimes the fruit of a plant. Exemplary vegetable oil includes, for example, almond oil, avocado oil, apricot kernel oil, canola oil, castor oil, coconut oil, corn oil, grapeseed oil, hazel seed oil, hemp oil, jojoba oil, macadamia oil, mango seed oil, olive oil, palm oil, peanut oil, pine nut oil, rapeseed oil, safflower seed oil, and sunflower oil. The vegetable oil includes tri-esters formed of three fatty acid molecules and glycerol (triglycerides) and may include free fatty acid molecules. Vegetable oil derivative includes monoglycerides (glycerol fatty acid ester) and diglycerides (diester of glycerol with two fatty acids) that may be formed, for example, by glycerolysis reaction between glycerol and triglycerides of the vegetable oil. Vegetable oil derivative may further include free fatty acids, salts of fatty acids formed, for example, by saponification of the vegetable oil, and esters of the fatty acids of the vegetable oil such as the esters of ethyl alcohol and the fatty acids of the vegetable oil. Vegetable oil derivative may include monglycerides and diglycerides of the vegetable oil coupled with polyethylene oxide to form PEGylated vegetable oil—etherification and esterification products of glycerides and fatty acids of the vegetable oil with ethylene oxide—see FIG. 11.

Note that the vegetable oil derivatives may include molecules with both a polar portion and a non-polar so that the vegetable oil derivatives may concentrate at interface between an antimicrobial solution including vegetable oil derivatives and a solid material in contact with the antimicrobial solution. Accordingly, the vegetable oil derivative may act as a surfactant that enhances wetting of the solid material such as a dental apparatus including pores by the antimicrobial solution.

An exemplary formulation of the antimicrobial solution is presented in Table 1. The components of the exemplary formulation of the antimicrobial solution as presented in Table 1 are listed by the component, the CAS (Chemical Abstracts Service) number of the component, the percentage of the component by weight in the exemplary formulation. Table 1 includes an exemplary range for each component in percentage by weight, as may be found in other exemplary formulations of the antimicrobial solution. Note that vegetable oil derivative includes macadamia oil derivative as Florasolvs PEG-16 Macadamia in the Table 1 formulation.

TABLE 1

| | | | RANGE (% BY |
|---|---|---|---|
| | | % BY WEIGHT | WEIGHT) IN OTHER |
| | | (EXEMPLARY | EXEMPLARY |
| COMPONENT | CAS # | FORMULATION) | FORMULATIONS |
| DEIONIZED WATER | | Q.S. | |
| PLANT-BASED | 8496-38-8 | 2.0 | 0.5-2.5 |
| ANTIMICROBIAL EXTRACT | | | |
| AS GRAPEFRUIT SEED | | | |
| EXTRACT (GSE) AS P-50 | | | |
| GLYCERIN 99% USP | 56-81-5 | 5.0 | 2.0-20.0 |
| GLACIAL ACETIC ACID | 64-19-7 | 0.25 | 0.2-1.0 |
| SODIUM ACETATE USP | 127-09-3 | 0.3 | 0.1-0.5 |
| VEGETABLE OIL | 220459-99-4 | 0.5 | 0.25-1.0 |
| DERIVATIVE AS | | | |
| FLORASOLVS PEG-16 | | | |
| MACADAMIA | | | |
| PEPPERMINT WATER SOLN. | | 0.5 | 0.05-1.0 |
| # 11837 FLAVORANT | | | |
| FD&C BLUE #1 | 3844-45-9 | 0.1 | 0.05-0.2 |
| COLORANT | | | |

The CAS number is a unique numerical identifier assigned to the component by the Chemical Abstracts Service that uniquely identifies the component. The Chemical Abstract Service has assigned a unique CAS number to each chemical substance described in the open scientific literature. The registry maintained by the Chemical Abstract Service includes chemical substances described from at least 1957 through the present and encompasses more than 81 million organic and inorganic substances and 64 million protein and DNA sequences. The registry is searchable by CAS number. Formulations of the antimicrobial solutions with components obtained from sources other than the specified sources, differing concentrations of the components, or components differing from that presented in exemplary Table 1 may be possible without departing from the scope of this invention as defined in the Claims.

Deionized water QS constitutes at least 90% of the antimicrobial solution by weight in the exemplary formulation of Table 1. Accordingly, the exemplary antimicrobial solution of Table 1 may be considered as dilute.

Grapefruit seed Extract (GSE), which is the plant-based antimicrobial extract in this exemplary formulation, is commercially available in liquid form as P-50 from Chemie Research and Manufacturing, PO BOX 181279, Casselberry, Fla. 32718. The GSE in the form of P-50 is exemplary, and other generally equivalent GSE from other suppliers may be used in other implementations of the antimicrobial solution. Note that GSE from some sources may contain benzyl alkonium chloride, and GSE that contains benzyl alkonium chloride may exhibit erratic performance as an antimicrobial agent. Therefore, it is important that the GSE not contain contaminants such as benzyl alkonium chloride as well as pesticide residue, herbicide residue, and the residue(s) of various other agricultural chemicals, in various implementations of the antimicrobial solution. P-50 has been found to be generally free of benzyl alkonium chloride and other contaminants.

P-50 is produced by Chemie Research and Manufacturing through the glycerin extraction of grapefruit pulp pellets obtained from the Florida Citrus Producers Cooperative. The grapefruit pulp pellets are a byproduct of various processing of grapefruits by the Florida Citrus Producers Cooperative. The solvent in this exemplary extraction process is glycerine, but the solvent may be water or other solvent(s), in other extraction processes. The GSE is initially a dark brown in color, and is diluted by the addition of glycerin to a lemon yellow in the final P-50 product. Thus, P-50 contains about 42% GSE. Accordingly, the 2.0% P-50 given in Table 1 translates to about 0.84% (by weight) GSE. The range of P-50 given in Table 1 translates to a range of about 0.21% GSE to about 1.05% GSE, by weight. The result of a spectral analysis of a sample of P-50 is given in Table 2. Physical properties of P-50 are given in Table 3 for a sample of P-50. The values in Table 2 and in Table 3 are provided for exemplary purposes only. It should be noted that P-50 is a product derived from agricultural sources, so that there may be some variation in the physical and chemical properties of P-50 in general correspondence with natural variations that may be inherent in the agricultural products from which P-50 is derived. GSE (as P-50) may be generally regarded as safe over the range of concentrations given in Table 1.

TABLE 2
RESULTS - ANALYSIS OF P-50 LIQUID

| COMPONENT | % BY WEIGHT |
|---|---|
| GRAPEFRUIT SEED | 42.07% |
| EXTRACT (GSE) | |
| ASCORBIC ACID (VITAMIN C) | 17.93% |
| GLYCERIN 99% USP | 38.38% |
| MOISTURE (MAX) | 1.62% |

TABLE 3
PROPERTIES OF P-50 LIQUID

| APPEARANCE | HEAVY VISCOUS LIQUID |
|---|---|
| COLOR | LEMON YELLOW TO |
| | GOLDEN BROWN |
| SPECIFIC GRAVITY | 1.19 |
| pH (D25° C.) | 2.26 |
| FLASH POINT | 292° F. |

GSE may contain a number of ingredients that exhibit antimicrobial activity. For example, the polyphenols found in GSE or in the seed or pulp extract derived from other fruits of genus Citrus may have antimicrobial activity. GSE, for example, may comprise at least some of the polyphenols quertcitin, quercetin glycoside, halperidin, campherol glycoside, apigenin, rutinoside, hepamothoxyflavone, and dihydrocampherol glycoside, which are stabilized by being converted to ammorium salts in the extract mixture. The flavonoids narigin, isocurametin, neohesperidin, hesperidin, poncirin, nebiletin, and tangeretin may be present in GSE or other seed or pulp extract of genus Citrus, and such flavonoids may provide antimicrobial activity.

Glycerine (1,2,3-trihydroxypropane-chemical formula C₃H₈O₃) acts as a stabilizer. Note that the P-50 includes glycerin. The glycerin listed in Table 1 is in addition to the glycerin included in the P-50.

Glacial acetic acid (ethanoic acid-chemical formula CH₃COOH) may act as a cleaning agent to remove micro-organisms as well as foreign matter from the dental appliance. Foreign matter may include, for example, stains, debris, scale, and so forth. In undiluted form, acetic acid is referred to as glacial acetic. Acetic acid is considered a hydrophilic polar protic solvent. As such, acetic acid may act as a cleaning agent by dissolving polar compounds such as sugars and inorganic salts. Acetic acid may also act as a cleaning agent by dissolving non-polar compounds such as oils. Acetic acid mixes with both polar and non-polar solvents. Note that table vinegar may range from about 4% to about 8% acetic acid. A 1.0 M acetic acid solution, which is about the same concentration of vinegar, has a pH of 2.4. The range of acetic acid given in Table 1 is generally less than the concentration of acetic acid in table vinegar, so that antimicrobial solutions having acetic acid concentrations within this range may be generally regarded as safe.

Sodium acetate (C₂H₃NaO₂) is the sodium salt of acetic acid formed, for example, by the reaction of acetic acid with sodium hydroxide (NaOH), which is the reaction of a weak acid with a strong base. Sodium acetate is used to buffer the antimicrobial solution at a higher pH that may be less irritation to skin and mucosal membranes such at those found in the mouth. As the conjugate base of acetic acid, the addition of sodium acetate to the antimicrobial solution may act as a buffer to maintain the pH of the antimicrobial solution in a mildly acidic range of from a pH of about 6 to a pH of about 4. Sodium acetate is used in various food products. For example, sodium acetate may be used to impart a salt and vinegar flavor to potato chips. Accordingly, sodium acetate may be generally regarded as safe over the range of concentrations given in Table 1. Acetic acid may be omitted in certain implementations of the antimicrobial solution, and a buffer, such as sodium acetate, may be omitted in certain implementations of the antimicrobial solution.

Macadamia nuts are the fruit of the Australian Tropical Evergreen Tree known as Queensland or Australian Nut. Macadamia oil may be obtained from the commercial macadamia tree M. Intergrifolia. Macadamia oil derivative includes ethyl macadamiate, which is the ester of ethyl alcohol and fatty acids derived from macadamia oil. Because palmitoleic acid is found in macadamia oil in concentrations as high as 21%, ethyl macadamiate may contain concentrations of ethyl palmitoleicate.

Macadamia oil derivative as PEG-16 macadamia oil derivative is the polyethylene glycol derivative of monglycerides and diglycerides of derived from macadamia oil. An exemplary PEG-16 macadamia oil derivative is commercially available as Florasolvs PEG-16 Macadamia from Floratech Americas, 291 East El Prado Court, Chandler, Ariz. 85225. Generally equivalent PEG-16 macadamia oil derivative available from other suppliers may be used in lieu of or in combination with Florasolvs PEG-16 Macadamia, in other implementations of the antimicrobial solution. HLB refers to the Hydrophilic-Lipophilic Balance, which is a measure of the degree to which a surfactant is hydrophilic or lipophilic. The PEG-16 macadamia oil derivative as Florasolvs PEG-16 Macadamia is a wetting agent as the HLB of macadamia oil derivative as Florasolvs PEG-16 Macadamia falls within the range of 11 to 14. PEG-16 macadamia oil derivative is a surfactant that may enhance wetting of the dental apparatus by the antimicrobial solution, and, thus, may enhance cleaning performance of the antimicrobial solution. The surface-activity of the PEG-16 macadamia oil derivative may assist the antimicrobial solution in penetrating pores within the dental appliance that may harbor micro-organisms within.

Beyond being a natural solubilizer and emulsifier, PEG-16 macadamia oil derivative may be included in various implementations of the antimicrobial solution due to the stability, health, healing, anti-inflammatory, and moisture properties that PEG-16 macadamia oil derivative may exhibit.

As a natural anti-inflammatory, PEG-16 macadamia oil derivative may not harm soft tissue and may be beneficial to damaged soft tissue. For example, dental appliances may cause gum irritation, cuts, and ulcers in the mouth. PEG-16 macadamia derivative may assist in the healing of damaged soft tissue. Moisturizing properties of PEG-16 macadamia derivative may help preserve the integrity of the dental appliance.

Exemplary Florasolvs PEG-16 Macadamia is not classified as hazardous or dangerous according to (EC) 1272/2008, 67/548/EEC, or 1999/45/EC. Ingestion of a single dose is unlikely to cause harm. This material is exempt from the Toxic Substances Control Act. Accordingly, macadamia oil derivative as Florasolvs PEG-16 Macadamia may be generally regarded as safe over the range of concentrations given in Table 1.

Peppermint water solution #11837 is commercially available from Berje Inc. 700 Blair Road Carteret, N.J., USA 07008. Peppermint water solution #11837 is exemplary, and generally equivalent flavorant available from other suppliers may be used in lieu of peppermint water solution #11837 in other implementations of the antimicrobial solution. Peppermint water solution #11837 is a water-soluble peppermint tflavorant used to impart a peppermint flavor to the antimicrobial solution. Peppermint water solution #11837 may include plant extracts from the peppermint plant, and may be commonly ingested. Accordingly, peppermint water solution #11837 may be generally regarded as safe over the range of concentrations given in Table 1.

The flavorant, if any, included in the antimicrobial solution may, at least in part, deodorize the dental appliance. Dental appliances tend to collect foreign matter over time, which may lend a foul odor to the dental appliance. The flavorant may mask this odor, and make the dental appliance more palatable to the user. The flavorant may be extracted from a plant, and various flavorant(s) having that impart various flavors such as lemon, lime, spearmint, eucalyptus, clove, and ginger may be used in the antimicrobial solution, in various implementations. The flavorant may be omitted from the antimicrobial solution, in certain implementations.

FD&C Blue #1 (C₃₇H₃₄N₂O₉S₃Na₂) is commercially available from Sciencelab.com Inc. 14025 Smith Rd. Houston Tex. 77396. FD&C Blue #1 is exemplary, and generally equivalent colorants available from other suppliers may be used in lieu of FD&C Blue #1 in other implementations of the antimicrobial solution. FD&C Blue #1 is an FDA approved colorant that is water soluble and that is used to give a light green color to the antimicrobial solution. Inclusion of a colorant, such as FD&C Blue #1, may enhance the visual presentation of the antimicrobial solution, for example, the uniformity of the antimicrobial solution's appearance. Other colorant(s) having other colors may be used in the antimicrobial solution, in other implementations. The colorant may be omitted from the antimicrobial solution, in yet other implementations. FD&C Blue #1 may be generally regarded as safe over the range of concentrations given in Table 1.

Certain implementations of the antimicrobial solution may include sodium benzoate, potassium sorbate, or combinations of sodium benzoate and potassium sorbate as stabilizer or preservative. For example, certain implementations of the antimicrobial solution include the sodium benzoate/potassium sorbate admixture in the form of Geogard Ultra/PPOH-35 sourced from Thor Specialties, Inc. of Trumbull, Conn.

Certain implementations of the antimicrobial solution may include PEGylated castor oil such as PEG-40 hydrogenated castor oil in the form of Cremophor® RH 40 sourced from BASF Corporation of Germany. The PEGylated castor oil may included in lieu of PEGylated macadamia oil.

The GSE or other plant-based antimicrobial extract agent in the antimicrobial solution may act to reduce the incidence of or eradicate micro-organisms from the dental appliance, while the acetic acid acts as a cleaning agent to remove stains and odors from the surfaces of the dental appliance. The macadamia oil derivative may act as surfactant that enhances wetting and, hence, penetration of the antimicrobial solution into pores of the dental appliance to contact the pores and micro-organisms within the pores with the antimicrobial solution. Accordingly, the GSE, the acetic acid, and the macadamia oil derivative may act synergistically with one another. The acetic acid acting as a cleaning agent acting to remove foreign matter from the dental appliance so that the GSE may better access to the micro-organisms obscured by the foreign matter to eradicate the micro-organisms from the dental appliance. The acetic acid may remove micro-organisms including those killed by the GSE from the dental appliance. By enhancing wetting, the vegetable oil derivative in the form of macadamia oil derivative may facilitate cleaning within pores by the acetic acid, and the macadamia oil derivative may facilitate eradication of micro-organisms within pores by the GSE.

The antimicrobial solution, in various formulations, does not include various components as may be found in other antimicrobial solutions that may cause irritation, allergic reactions, or other deleterious effects to the user. The antimicrobial solution in the exemplary formulation of Table 1 does not include or any multivalent metal cation such as Al⁺⁺⁺, Cu⁺⁺, or Zn⁺⁺. Metal cations such as Al⁺⁺⁺, Cu⁺⁺ or Zn⁺⁺ have been included in other antimicrobial solutions to increase the effectiveness of antimicrobial properties of such other antimicrobial solutions and to fight oral malodor. The antimicrobial solution in the exemplary formulation of Table 1 does not include non-alkali metal cations such as Ag⁺. EDTA may be included in such other antimicrobial solutions as a chelating agent to assist in reducing the amount of absorption of multivalent metal cations into the body. The antimicrobial solution disclosed herein foregoes such multivalent metal cations.

The antimicrobial solution, in various formulations, does not include anti-calculus agents like phosphate, pyrophosphate, polyphosphate, phosphonate, polyphosphonate, and aluminum compounds are common ingredients found in dental care products. Such anti-calculus agents may cause skin irritation or allergy in the user.

The antimicrobial solution, in various formulations, does not include anti-plaque agents. Examples of anti-plaque agents may include xylitol, ammonium fluoride, chlorothymol, stannous fluoride, and urea peroxide.

The antimicrobial solution, in various formulations, does not include fluoride. The antimicrobial solution of the exemplary formulation of Table 1 does not include fluoride, alcohol, alkanediols, Cholorheidine Gluconate, tocopheryl acetate, or hydrogen peroxide.

The antimicrobial solution, in various formulations, does not include a desensitizing agent. Examples of desensitizing agents, which may act as anti-pain agents for topical treatment of sore gums and inner cheeks, include strontium chloride, potassium nitrate, natural herbs like gall nut, asarum, cubebin, Galasega, and other non-steroidal anti-inflammatory agents.

The antimicrobial solution, in various formulations, does not include a chemically-derived malodor control agent for fighting micro-organisms in the user's mouth that cause, e.g., halitosis (“bad breath”). Examples of chemically derived moral malodor control agents may include triclosan, phthalic acid and its salts, magnesium mono-potassium phthalate, chlorhexidine, sanguinarine, benzalkonium chloride, salicylanilide, domiphen bromide, and tetradecylpyridinium chloride (“TPC”).

The antimicrobial solution, in various formulations, does not include parabens or sodium lauryl sulfate (“SLS”).

The antimicrobial solution, in various formulations, does not include an H-2 antagonist, which is a compound that block H-2 receptors and that may lead to skin irritation, redness, swelling, and anaphylactic side effects.

In preparing the antimicrobial solution, for example, the exemplary formulation of Table 1, the glycerin and glacial acetic acid may be added consecutively to the deionized water in a tank and mixed. Next, the GSE may be added to the mixture and thoroughly mixed. Then, the sodium acetate may be added to the mixture. Finally, the Peppermint water solution #11837, the macadamia oil derivative as Florasolvs PEG-16 Macadamia, and the FD&C Blue #1 may be added to the mixture, in no particular order. The mixture may be thoroughly mixed in the tank by means of an impeller mixer at room temperature. The amount of colorant added may be adjusted to attain a desired color of the antimicrobial solution. The resulting antimicrobial solution may be stored at room temperature until use.

The formulation of antimicrobial solution as given in Table 1 was tested in a disk diffusion assay. As set forth in Table 1, the formulation of antimicrobial solution so tested included 2% GSE (as P-50), 5% glycerin, 0.04165M sodium acetate, and 0.04165M acetic acid. Tests were performed in duplicate, and distilled water was used as a negative control. Sterile paper disks soaked with 20 μL of antimicrobial solution were placed on agar plates spread with each species of bacteria. The plates were incubated overnight at 35° C., and diameters of clear zones of growth inhibition were measured in millimeters. Averages of the results for the duplicate tests are given in FIG. 8.

As illustrated in FIG. 8, the test included the micro-organisms:
E. coli (Gram-negative) facultative anaerobe found in the gut. While most are harmless, some variants may cause food poisoning.
L. monocytogenes (Gram-positive) is a facultative anaerobe that causes listerosis. May be a virulent food borne pathogen.
S. flexneri (Gram-negative) causes diarrhea in humans May be resistant to antibiotics
S. Pyogenes (Gram-positive)—hemolysis—mild superficial skin infections to life-threatening systemic diseases usually beginning in the throat (pharyngitis) or skin (impetigo)
S aureus (Gram-positive)—S. aureus can cause a range of illnesses, from minor skin infections such as pimples, impetigo, boils (furuncles), cellulitis folliculitis, carbuncles, scalded skin syndrome, and abscesses to serious conditions such as pneumonia, meningitis, osteomyelitis, endocarditis, sepsis, toxic shock syndrome, and bacteremia. Its incidence ranges from skin, soft tissue, respiratory, bone, joint, endovascular to wound infections. It is still one of the five most common causes of nosocomial infections and is often the cause of postsurgical wound infections.

As illustrated in FIG. 8, the antimicrobial solution is effective against the range of micro-organisms in the test. The micro-organisms in the test include both Gram-positive and Gram-negative bacteria. The micro-organisms in the test encompass both common generally benign bacteria and pathogens.

Various exemplary formulations of the antimicrobial solution, which are given in Table 4, were tested by disk diffusion assay for effectiveness as an antimicrobial agent against a suite of micro-organisms. Distilled MilliQ water was used as a negative control. All of the formulations of Table 4 contained 2% GSE, 0.04165M Na Acetate, 0.04165M Acetic Acid, and 5% glycerin. The variations in the formulations of Table 4 were in the flavorant and colorant. The formulations of Table 4 include various combinations of no flavorant, peppermint flavorant, or spearmint flavorant and either blue colorant or no colorant.

In conducting the tests of the Table 4 formulations, sterile paper disks soaked with 20 μL of solution were placed on agar plates spread with each species of bacteria. The plates were incubated overnight at 35° C., and diameters of zones of growth inhibition were measured in millimeters. Each assay was performed in duplicate. Diameters of zones of growth inhibition were measured, and averages were found for duplicate assays.

TABLE 4

| FORMULATION | FLAVORANT | COLORANT |
|---|---|---|
| MAC1 5-21-14 | NONE | BLUE |
| MAC1 PEPPERMINT | PEPPERMINT | BLUE |
| MAC1 SPEARMINT | SPEARMINT | BLUE |
| MAC1 4-26-14 | NONE | NONE |

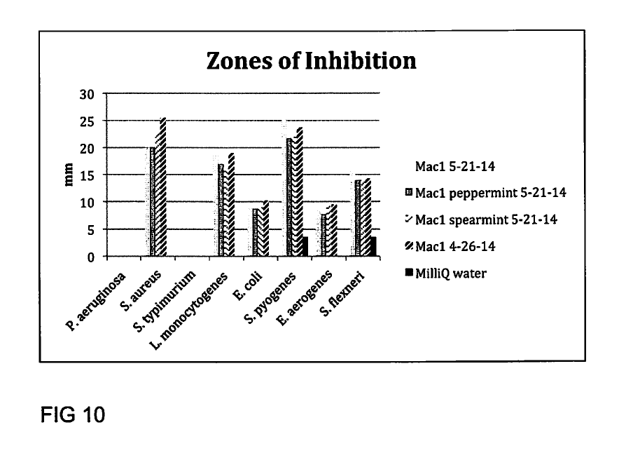

In the tests of the Table 4 formulations, the largest growth inhibition was observed for S. aureus and S. pyogenes and some inhibited growth was observed for S. flexneri, L. monocytogenes, E. coli and E. aerogenes. Results are presented graphically in FIG. 10, which plots the diameters of zones of growth inhibition in mm for each micro-organism tested. As indicated in FIG. 10, the presence or absence of colorant in the antimicrobial solution did not appear to materially alter the effectiveness of the antimicrobial solution against the micro-organisms tested. Similarly, neither the presence or absence of the flavorant nor the type of flavorant (peppermint or spearmint) appeared to materially alter the effectiveness of the antimicrobial solution against the micro-organisms tested, as indicated in FIG. 10.

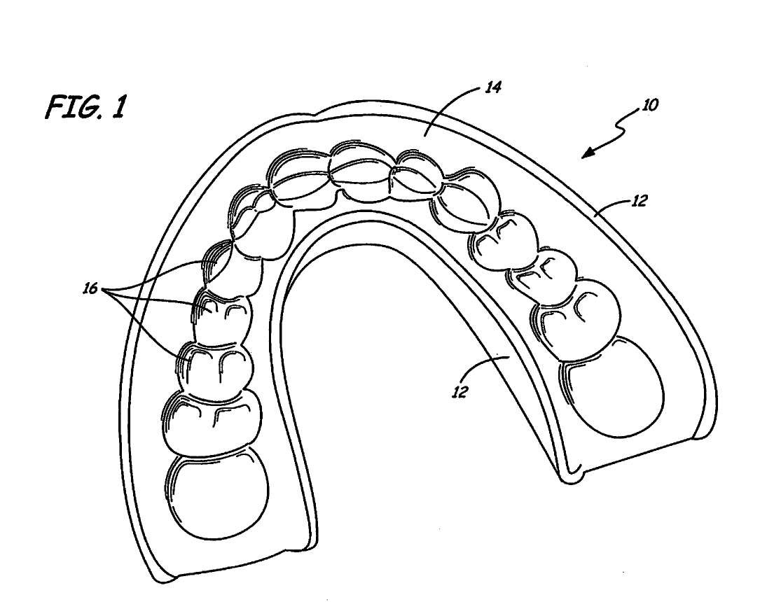

The antimicrobial solution may be provided to the end user in the form of a liquid cleansing rinse or soaking solution. An exemplary dental appliance 10, which is in the form of a mouth guard, is illustrated in FIG. 1. Meant to be worn by a user around the upper line of teeth, this implementation of dental appliance 10 comprises an exterior u-shaped body 12 containing a thermally-moldable plastic material 14 in which the user's teeth have been inset to form an imprint 16 therein for each tooth, as illustrated. When the dental appliance 10 is placed into the user's mouth and along the upper gum line, the user's teeth enter these imprint channels 16 so that the mouth guard may fit around the teeth and gum line to protect the teeth.

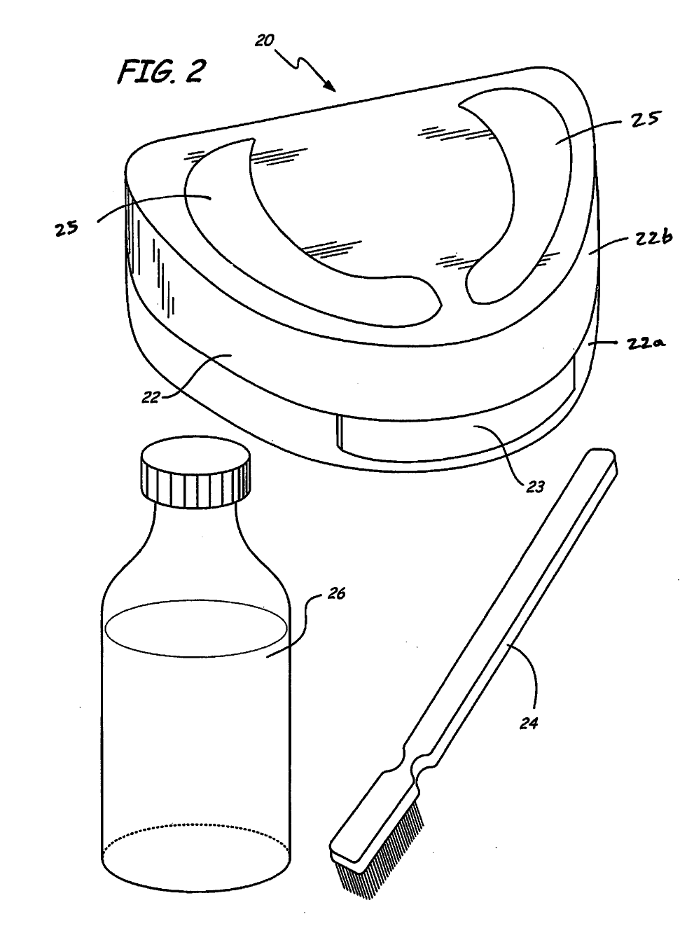

As shown in FIG. 2, an exemplary cleaning kit 20 includes a protective case 22 for holding the dental appliance such as the dental appliance 10, a soft bristled brush 24, and a bottle 26 containing a formulation of the antimicrobial solution as disclosed herein. The case 22 may be made from any appropriate cleanable material including plastic, ceramic, glass, or metal. The case 22 contains a housing 22a and lid 22b, which is hinged to the housing along its one edge (not shown) and releaseably secured to the housing along another edge by means of clasp 23, in this implementation. Alternatively, in other implementations, the lid housing 22b may contain a lip extending around its perimeter, which cooperates with a rabbit groove extending around housing 22a so that the lid may be snap fitted onto the housing. The lid may feature optional vents 25 for allowing air to circulate into the case containing the dental appliance to remove moisture that may allow micro-organisms to grow within case 22.

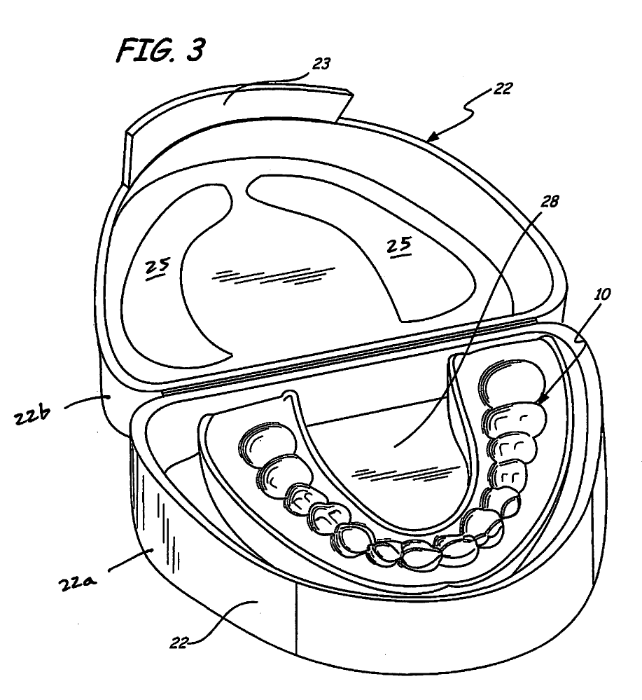

As shown in FIG. 3, case 22 may be sized, so that its interior volume 28 not only accommodates the dental appliance 10, but also secures dental appliance 10 in place without allowing dental appliance 10 to slide around, which may cause damage to dental appliance 10.

For daily cleaning, for example, the dental appliance 10 may have a portion of the antimicrobial solution poured onto it for less than one minute, followed by light brushing using brush 24 to enhance contact by the antimicrobial solution with micro-organisms existing on the surfaces 14 of the dental appliance 10 and inside tooth imprint channels 16 therein. The dental appliance 10 may then be rinsed with cool water and stored in case 22.

For weekly cleaning, for example, the dental appliance 10 may be soaked in the antimicrobial solution, which has been poured into the case 22 or other suitable container holding the dental appliance 10. The dental appliance 10 may be soaked in this antimicrobial solution for a time period ranging from one minute to 24 hours. The dental appliance 10 may be soaked in this antimicrobial solution for a time period ranging from 10 minutes to 12 hours. The dental appliance 10 may be soaked in this antimicrobial solution for a time period ranging from 15-30 minutes. Following soaking, the dental appliance 10 may be removed from the container, brushed with brush 24, rinsed with cool water, and stored in case 22.

In various other implementations, the dental appliance 10 may be soaked in the cleaning composition for 2-24 hours or for a time period ranging 3-12 hours, depending upon the amount of micro-organisms collected by the dental appliance 10.

In an alternate mini-wipes embodiment 40 shown in FIG. 4, the antimicrobial solution may be incorporated into a towelette 42, which may be contained within an airtight package 44 until use. Such towelettes 42 may be made from paper, cloth, or other fiber products, and the towelettes 42 may be provided as discrete sheets or tear away panels. Each sheet or panel may be impregnated with the antimicrobial solution, to ensure full coverage by the solution throughout the sheet. The towelette 42 should be robust enough to not disintegrate upon use; but may be designed to biodegrade over time after its use, in various implementations. For example, the towelettes 42 may comprise a spun-lace, non-woven fabric made from, e.g., 100% cotton, 50%° viscose, or 50% polyester, in various implementations.

The towelette panel size may be approximately 2.75 inches×4 inches (7.5 cm×10 cm), in various implementations. The towelettes 42 may be packaged in a moisture-impermeable container 46 made from thin, flexible material, such as plastic, vinyl, or foil. Unless only a single towelette is contained in such a package 46 (i.e., a single-use wipe), the package may contain a peel-away flap 48 for dispensing one towelette sheet at a time to the user with a re-seal capability for securing the flap 48 to the package to keep the unused towelettes moist. The package 46, in this implementation, has a small hook and loop fastener strip on its back to enable the user to attach the towelette package 46 to a cooperating hook and loop fastener strip mounted to a side of the dental appliance case 22, so that towelettes containing the antimicrobial solution of this invention may be available with case 22 for cleaning the dental appliance 10.

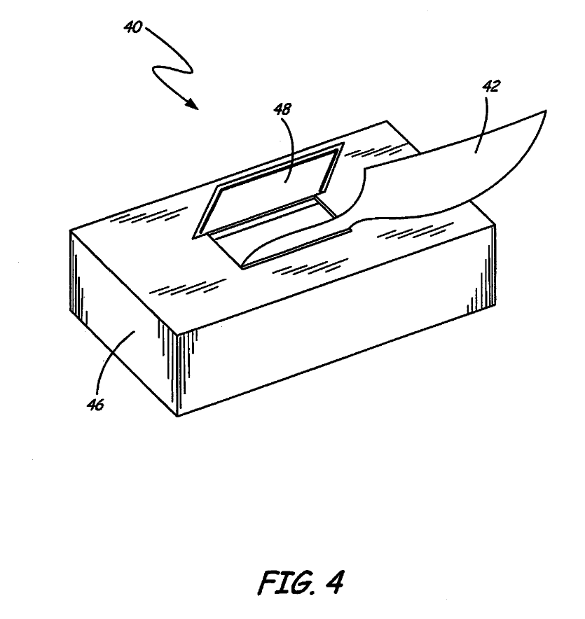

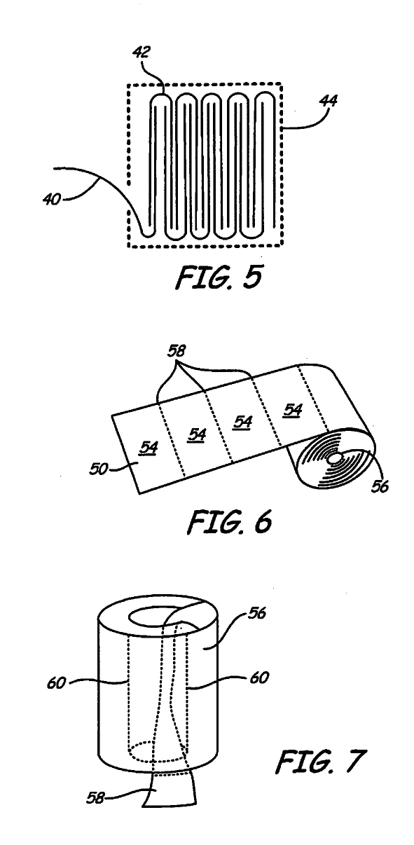

The towelettes 42 rectangular or square panels may be folded in upon themselves in bipartite panels overlapping between individual towelettes in an “accordion” arrangement, as shown in FIG. 5. In this manner, pulling the leading edge 40 of a towelette 42 to take possession of it will cause the next towelette 42 to be pulled forward to the standby position, in this implementation. A block of, e.g., 15 sheets stacked in this accordion arrangement may be dropped into the package and sealed to maintain the moisture of the antimicrobial cleaning solution, in various implementations.

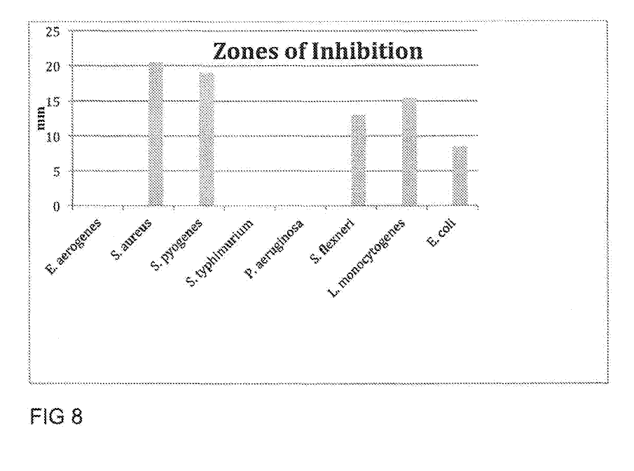

Instead of individual towelettes, the towelette may also constitute one long ribbon 50 on a roll with a multitude of serrated cuts 52 to form individual panels 54, as illustrated in FIG. 6. The towelette roll may be wound into a roll 56, so that pulling the first panel will not only allow it to be separated from the roll along the serration line, but also pull the next panel into the standby position. In still another implementation, the towelette ribbon 50 may be internally wound so that the leading edge 58 is on the inside of the roll, instead of the outside, as illustrated in FIG. 7. Such an arrangement, with internal winding 60 of the ribbon roll, may provide more resistance to the towelettes as they are pulled and separated from the roll, and may contain the antimicrobial solution impregnated within the towelettes more completely in order to reduce evaporation.

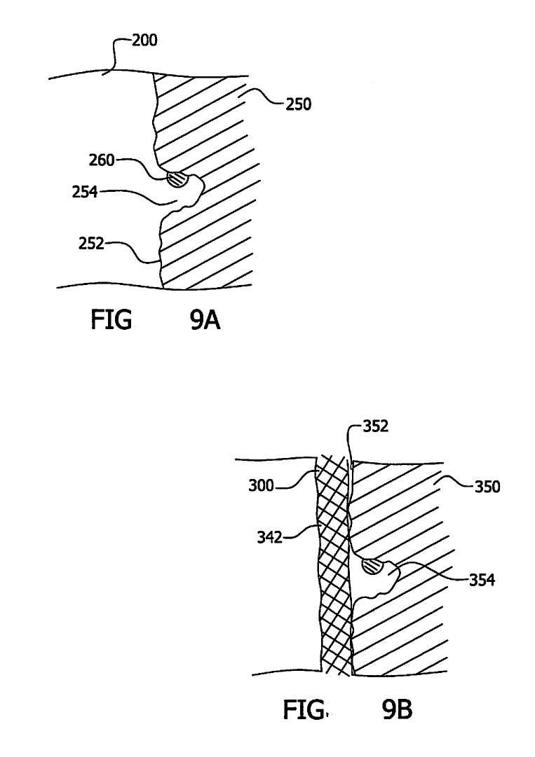

In use, the antimicrobial solution 200 may contact a surface 252 of dental appliance 250, as illustrated in FIG. 9A, by immersion of dental appliance 250 into antimicrobial solution, by being sprayed upon dental appliance 250, or being poured upon dental appliance 250. Micro-organisms 260, which adhere to surface 252, may be growing on surface 252 including within pore 254 formed in dental appliance 250, and the antibacterial solution 200 may penetrate pore 254 to eradicate micro-organisms 260 within pore 254. The surfactant properties of macadamia oil derivative and the solvent and hydrophylic polar protic properties of acetic acid may enhance the penetration of antimicrobial solution 200 into pore 254, and, hence, the eradication of micro-organisms 260 including within pore 254. Exemplary pore 254 may be formed in either a metal portion or a plastic portion of dental appliance 250, in various implementations.

In use, the antimicrobial solution 300 be included within towlette 342, as illustrated in FIG. 9B. Towelette 342 may be biased against surface 352 of dental appliance 350 to apply the antimicrobial solution 300 to surface 350 in order to eradicate micro-organisms on surface 352 and to wipe foreign matter from surface 352. Antimicrobial solution 300 may penetrate from towelette 342 into pore 354 to eradicate micro-organisms within pore 354, in this implementation.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. The Abstract is not intended to identify key elements of the compositions of matter disclosed herein or to delineate the scope thereof. Upon study of this disclosure and the exemplary implementations herein, one of ordinary skill in the art may readily recognize that various changes, modifications and variations may be made thereto without departing from the spirit and scope of the inventions as defined in the following claims.

What is claimed is:

1. An antimicrobial solution consisting of:
water;
extracted material obtained by glycerol extraction from one or more of seeds, pulp, and fruit of a plant of the genus Citrus, at least one of the one or more materials has anti-microbial properties and is at a concentration in said antimicrobial solution effective to eradicate micro-organisms;
glycerol;
acetic acid buffered by a buffer to maintain said antimicrobial solution at a pH between about 4 and about 6;
surfactant comprising one or more surfactant materials selected from glycerides of a vegetable oil, fatty acids of the vegetable oil, esters of fatty acids of the vegetable oil and ethoxylated vegetable oil;
colorant; and
flavorant.

2. The antimicrobial solution of claim 1, the one or more materials comprise a polyphenol.

3. The antimicrobial solution of claim 1, the one or more materials comprise ascorbic acid.

4. The antimicrobial solution of claim 1, the vegetable oil comprises macadamia oil.

5. The antimicrobial solution of claim 1, wherein the esters of fatty acids of the vegetable oil comprise ethyl esters of fatty acids.

6. The antimicrobial solution of claim 1, wherein the esters of fatty acids of the vegetable oil comprise ethyl macadamiate.

7. The antimicrobial solution of claim 1 and a surface of a dental appliance having micro-organisms resident upon the surface, the micro-organisms in contact with the antimicrobial solution.

8. The dental appliance of claim 7 comprises a mouth guard.

9. The antimicrobial solution of claim 1 and a solid material in contact with said antimicrobial solution for disinfection by said antimicrobial solution.

10. The antimicrobial solution of claim 1 and a towelette that incorporates said antimicrobial solution.

11. An antimicrobial solution consisting of:
water;
grapefruit seed extract (GSE) at a concentration in said antimicrobial solution effective to eradicate micro-organisms;
acetic acid buffered by a buffer to maintain said antimicrobial solution at a pH of from about 4 to about 6;
surfactant comprising one or more surfactant materials selected from glycerides of a vegetable oil, fatty acids of the vegetable oil, esters of fatty acids of the vegetable oil and ethoxylated vegetable oil;
glycerine;
colorant; and
flavorant.

12. The antimicrobial solution of claim 11, the grapefruit seed extract comprises a polyphenol.

13. The antimicrobial solution of claim 11, the grapefruit seed extract comprises ascorbic acid.

14. The antimicrobial solution of claim 11, the vegetable oil comprises macadamia oil.

15. The antimicrobial solution of claim 11, wherein the esters comprise ethyl esters.

16. The antimicrobial solution of claim 11, wherein the esters comprise ethyl macadamiate.

17. The antimicrobial solution of claim 11 and a solid material in contact with said antimicrobial solution for disinfection by said antimicrobial solution.

18. An antimicrobial solution consisting of:
water;
one or more materials obtained from one or more of seeds, pulp, and fruit of a plant of the genus Citrus, the one or more materials having anti-microbial properties and at a concentration in said antimicrobial solution effective to eradicate micro-organisms;
acetic acid buffered to maintain said antimicrobial solution at a pH between about 4 and about 6;
surfactant comprising one or more surfactant materials selected from glycerides of a vegetable oil, fatty acids of the vegetable oil, esters of fatty acids of the vegetable oil and ethoxylated vegetable oil;
colorant; and
flavorant.

19. The antimicrobial solution of claim 18, wherein the vegetable oil comprises macadamia oil.

20. The antimicrobial solution of claim 18, wherein the esters of free fatty acids comprise ethyl macadamiate.

21. An antimicrobial solution consisting of:
water;
grapefruit seed extract (GSE) at a concentration in said antimicrobial solution effective to eradicate micro-organisms;
surfactant comprising one or more surfactant materials selected from glycerides of a vegetable oil, fatty acids of the vegetable oil, esters of fatty acids of the vegetable oil and ethoxylated vegetable oil;
a stabilizer comprising one or more stabilizer materials selected from sodium benzoate and potassium sorbate;
colorant; and
flavorant.

22. An antimicrobial solution consisting of:
water;
grapefruit seed extract (GSE) at a concentration in said antimicrobial solution effective to eradicate micro-organisms;
surfactant comprising one or more surfactant materials selected from glycerides of a vegetable oil, fatty acids of the vegetable oil, esters of fatty acids of the vegetable oil and ethoxylated vegetable oil;
a concentration in said antimicrobial solution effective to eradicate micro-organisms;
acetic acid buffered to maintain said antimicrobial solution at a pH between about 4 and about 6;
a stabilizer comprising one or more stabilizer materials selected from sodium benzoate and potassium sorbate;
colorant; and
flavorant.
